(19) United States
(12) Patent Application Publication
(10) Pub. No.: US 2018/0009131 A1
(43) Pub. Date: Jan. 11, 2018

(54) Misting Lubricant

(71) Applicants: Arshak Isajanyan, San Jose, CA (US); Vahan Isajanyan, San Jose, CA (US)

(72) Inventors: Arshak Isajanyan, San Jose, CA (US); Vahan Isajanyan, San Jose, CA (US)

(21) Appl. No.: 15/201,991

(22) Filed: Jul. 5, 2016

(51) Int. Cl. B28D 5/00; B24B 55/02; B24B 9/16

(52) U.S. Cl. CPC B28D 5/0076; B24B 9/16; B24B 55/02

(57) ABSTRACT

Misting Lubricant may include the application of a liquid medium via a high-pressure mist nozzle instead of a conventional drip process. By utilizing misting lubricant, the lubricant may be evenly applied, and surface irregularities may be minimized, which may reduce or eliminate splashing. Misting lubricant may provide for a cleaner and more efficient material cutting process.

### FIELD

This disclosure relates generally to a misting lubricant.

### BACKGROUND

When cutting gems, a lubricant may be dripped on the gem or the cutting surface to remove waste and reduce heat. The lubricant is often a liquid such as oil or water. When the lubricant is dripped on the cutting medium, it often splashes, which causes waste and requires additional cleaning and maintenance of the equipment.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, techniques for providing a misting lubricant. In one embodiment, the application of a liquid lubricant via a high-pressure mist nozzle may be used instead of a conventional drip process. Under a conventional process, a lubricant may be dripped onto a cutting lop when cutting a gem, which may create uneven surface tension across the lubricant. This uneven surface tension may cause splashing, which may reduce the precision and accuracy of the cut being made. Drops of lubricant may also collect dust from the cutting process, which may require additional cleanup, and may also cause an uneven cut. In contrast, by utilizing a misting lubricant, the cutting lubricant may be evenly applied, and splashing and surface irregularities may be reduced or eliminated. This may allow for a better cut, and may reduce clean up effort.

Misting lubricant may provide for a more efficient material cutting process. For example, misting may reduce lubricant waste, which may reduce the cleaning and maintenance of equipment. Thus, this process may produce a better gemstone more efficiently.

Many of the attendant features may be more readily appreciated as they become better understood by reference to the following detailed description considered in connection with the attached drawings.

### BRIEF DESCRIPTION OF THE DRAWINGS

FIG. 1 illustrates a cutting device capable of supporting misting lubricant, according to one embodiment.

FIG. 2 illustrates components for misting lubricant.

### DETAILED DESCRIPTION

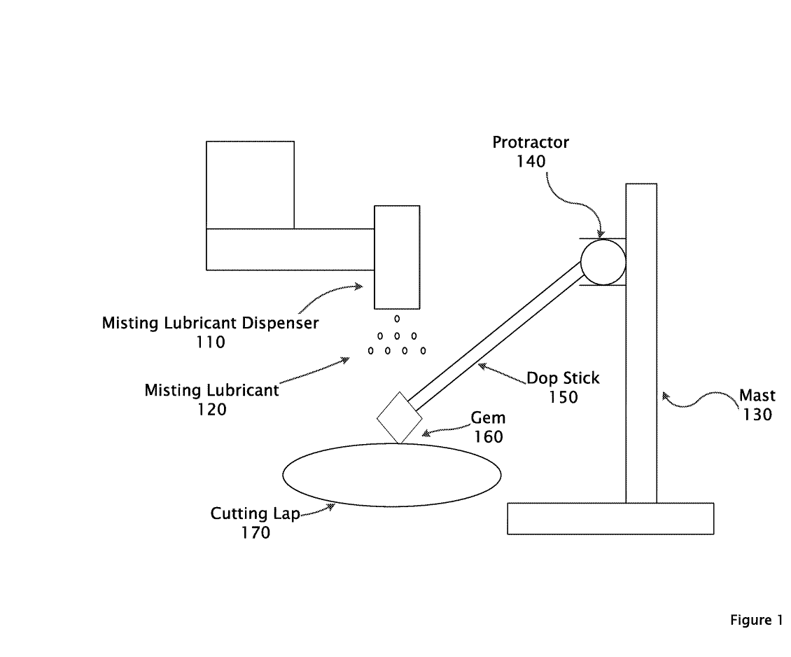

FIG. 1 illustrates a cutting device capable of supporting misting lubricant, according to one embodiment. Misting Lubricant Dispenser 110 may be located above, or anywhere near Gem 160, which may be being cut or polished. Misting Lubricant 120 may spray over Cutting Lap 170 to help cool and lubricate where Gem 160 is being cut. Mast 130 may adjustably support Dop Stick 150, at an angle controlled at Protractor 140.

Misting Lubricant 120 may provide for a more efficient material cutting process. For example, Misting Lubricant 120 may reduce lubricant waste compared to a conventional lubrication dripping process. Using less lubricant may reduce the cleaning and maintenance of equipment. Lubricant often collects dust and other particles from the material being cut, and drops of lubricant may splash and deposit these particles over more of the equipment than Misting Lubricant 120. Thus, this process may produce a better gemstone more efficiently.

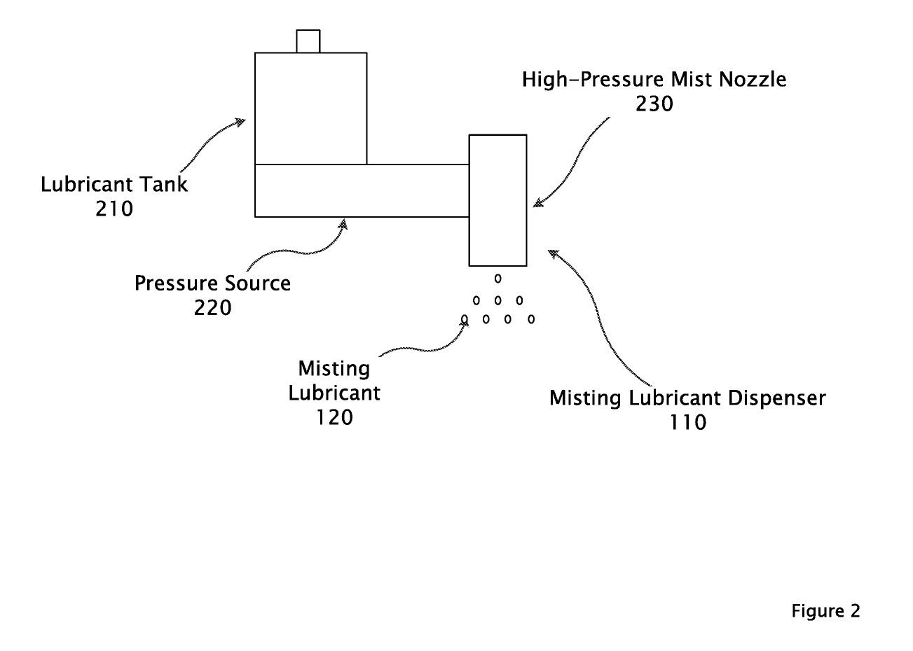

FIG. 2 illustrates components for misting lubricant according to another embodiment. Lubricant Tank 210 may provide liquid, for example, oil or water, to act as a lubricant, which may wash away debris and keep Gem 160 from overheating. High-Pressure Mist Nozzle 230 may control pressure and flow of mist. Pressure Source 220 may be a pump, or may an external source, such as a compressed air tank or an external compressor. Misting Lubricant 120 may be applied to Cutting Lap 170 or Gem 160.

One having skill in the art will recognize that misting lubricant may also be used for applications other than cutting or polishing gems. Many forms of cutting may benefit from misting rather than dripping lubricant.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

1. A device, comprising:
a tank containing lubricant;
a source operable to pressurize the lubricant; and
a high-pressure mist nozzle coupled to the tank, the nozzle located to provide a misting lubricant near a cutting lap.

2. A method for lubricating while cutting a gem, comprising:
releasing a lubricant through a high-pressure mist nozzle, giving a misting lubricant; and
applying the misting lubricant to a cutting lap near the gem while the gem is being cut or polished.
